(19) United States
(12) Patent Application Publication
(10) Pub. No.: US 2024/0320661 A1
(43) Pub. Date: Sep. 26, 2024

(54) SECURE COMPUTING SYSTEM, METHOD, STORAGE MEDIUM, AND INFORMATION PROCESSING SYSTEM

(71) Applicant: NEC Corporation, Minato-ku, Tokyo (JP)

(72) Inventors: Daisuke MATSUDA, Tokyo (JP); Yoshiyuki ETOU, Tokyo (JP); Satoru FUJII, Tokyo (JP); Ryo FURUKAWA, Tokyo (JP); Walaru ITONAGA, Tokyo (JP)

(73) Assignee: NEC Corporation, Minato-ku, Tokyo (JP)

(21) Appl. No.: 18/574,855

(22) PCT Filed: Jul. 8, 2021
(86) PCT No.: PCT/JP2021/025728

§ 371 Date: Dec. 28, 2023

(51) Int. Cl. G06Q 20/38; G06Q 20/40; H04L 9/08

(52) U.S. Cl. CPC G06Q 20/382; G06Q 20/401; H04L 9/085

(57) ABSTRACT

A secure computing system according to an aspect of the present disclosure includes: at least one memory configured to store instructions; and at least one processor configured to execute the instructions to: perform, based on a plurality of models and financial transaction information about a customer to be analyzed, analysis regarding a financial transaction of the customer to be analyzed, through secure computation using each of the models, the plurality of models having been generated for a plurality of financial institutions based on financial transaction information about customers held by each of the financial institutions; and output results of the analysis performed by the secure computing means using the plurality of models.

### TECHNICAL FIELD

The present disclosure relates to a secure computing system and the like.

### BACKGROUND ART

In recent years, machine learning is performed on sensitive data such as personal information, and data analysis based on a generated learning model is performed. It is desirable that data required to be confidential be analyzed in a concealed form. PTL 1 discloses a secure computing system that can perform computation while data is encrypted.

PTL 2 discloses a system that utilizes data without disclosing details of data owned by each company to other companies. PTL 3 discloses a method of transforming a prediction model and distributing the transformed prediction model by a secret sharing method.

### CITATION LIST

### Patent Literature

PTL 1: Japanese Patent No. 6795863
PTL 2: Japanese Patent No. 6803598
PTL 3: JP 2019-215512 A

### SUMMARY OF INVENTION

### Technical Problem

A financial institution is one of organizations that can utilize analysis using a learning model. Since information about customers held by each financial institution is different, there is a possibility that a result obtained by a learning model based on information held by one institution may be different from a result obtained by a learning model based on information held by another institution. However, it is difficult to give the learning model of the one institution to the other institution in order to confirm an analysis result of the other learning model. PTLs 1 to 3 do not particularly mention that analysis results of a plurality of learning models are used.

An object of the present disclosure is to provide a secure computing system and the like that enable use of an analysis result of each model without leaking a model of each financial institution.

### Solution to Problem

A secure computing system according to the present disclosure includes a secure computing means that performs, based on a plurality of models and financial transaction information about a customer to be analyzed, analysis regarding a financial transaction of the customer to be analyzed, through secure computation using each of the models, the plurality of models having been generated for a plurality of financial institutions based on financial transaction information about customers held by each of the financial institutions, and an output means that outputs results of the analysis performed by the secure computing means using the plurality of models.

A method according to the present disclosure includes performing, based on a plurality of models and financial transaction information about a customer to be analyzed, analysis regarding a financial transaction of the customer to be analyzed, through secure computation using each of the models, the plurality of models having been generated for a plurality of financial institutions based on financial transaction information about customers held by each of the financial institutions, and outputting analyzed analysis results of the models.

A program according to the present disclosure causes a computer to execute performing, based on a plurality of models and financial transaction information about a customer to be analyzed, analysis regarding a financial transaction of the customer to be analyzed, through secure computation using each of the models, the plurality of models having been generated for a plurality of financial institutions based on financial transaction information about customers held by each of the financial institutions, and outputting computed analysis results of the models.

### Advantageous Effects of Invention

According to the present disclosure, it is possible to use an analysis result of each model without leaking a model of each financial institution.

### BRIEF DESCRIPTION OF DRAWINGS

FIG. 1 is a block diagram illustrating a configuration of an information processing system 10 according to a first example embodiment.

FIG. 2 is a diagram illustrating an example of analysis results.

FIG. 3 is a diagram illustrating another example of analysis results.

FIG. 4 is a diagram illustrating an example of output based on the analysis results.

FIG. 5 is a diagram illustrating an example of output based on the analysis results.

FIG. 6 is a diagram illustrating another example of output based on an analysis result.

FIG. 7 is a diagram illustrating an example of comparison between analysis results and an aggregation result.

FIG. 8 is a flowchart illustrating an example of an operation of a secure computing system 100.

FIG. 9 is a block diagram illustrating a configuration of an information processing system 11 according to a second example embodiment.

FIG. 10 is a flowchart illustrating an example of an operation of the information processing system 11.

FIG. 11 is a block diagram illustrating an example of a hardware configuration of a computer 500.

### EXAMPLE EMBODIMENTS

### First Example Embodiment

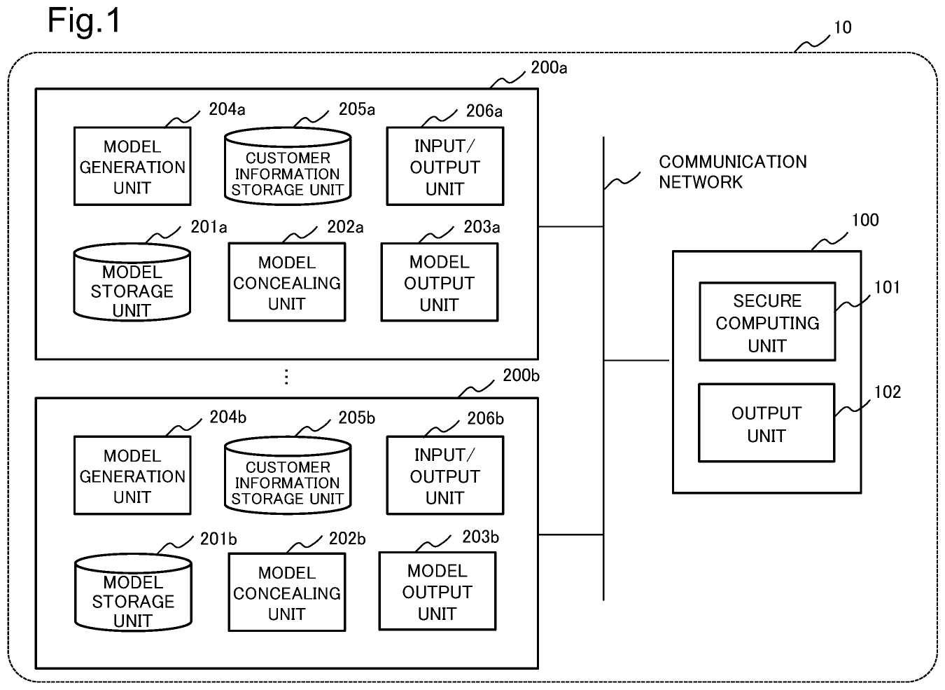

FIG. 1 is a block diagram illustrating a configuration of an information processing system 10 according to a first example embodiment. The information processing system 10 according to the first example embodiment is a system that performs analysis regarding a financial transaction based on financial transaction information using a model held by each of financial institutions. The analysis regarding the financial transaction is, for example, analysis for supporting the financial transaction between a financial institution and a customer. The analysis regarding the financial transaction includes analysis for assisting the financial institution in advising a corporation.

The financial institutions include, for example, a credit card company and a settlement business operator that handles cashless payment in addition to business operators that handle financial products, such as banks (including city banks, Japan Post Bank, regional banks, credit associations, and credit associations), a securities company, or an insurance company. As a financial institution in the first example embodiment, an article lessor that performs a leasing business or a rental business of automobiles and home electric appliances is also included. Examples of the financial products include a deposit, a bond, an investment trust, a foreign currency, insurance, a stock, a future transaction, FX, a virtual currency, and the like.

Customers include an individual customer and a corporate customer. The financial transaction information includes, for example, a status of a past transaction such as past deposit/withdrawal information of an account and information of a financial product purchased in the past. The financial transaction information may further include a customer attribute. In the case of an individual customer, the customer attribute includes, for example, attributes such as an occupation, a gender, an age, a residence, and a family structure of the customer.

The financial transaction information may not include at least a part of the above-described information, and may include information other than the above-described information.

The financial institutions advise an individual customer to purchase a financial product, for example, based on an analysis of a recommended financial product for the customer or a customer to whom purchase of a financial product should be suggested. The financial institutions can provide corporate customers with advice on financial management strategies and financial product transactions. The financial institutions support M & A or recommend financial products/services, for example, based on the analysis.

Referring to FIG. 1, the information processing system 10 includes a secure computing system 100 and a plurality of financial institution systems 200 (200a, 200b). In FIG. 1, the number of financial institution systems 200 is two, but is not limited thereto. The number of financial institution systems 200 may be equal to the number of financial institutions participating in analysis by the information processing system 10.

The secure computing system 100 is operated by, for example, a service provider that provides a financial analysis service tool or the like to each financial institution. The service provider provides a financial analysis service or the like for aggregating analysis results of models acquired from each financial institution system 200.

### <Financial Institution Systems 200>

Each of the financial institution systems 200 is an example of a first system. Each of the financial institution systems 200 includes a model storage unit 201 (201a, 201b), a model concealing unit 202 (202a, 202b), and a model output unit 203 (203a, 203b). The financial institution systems 200 are owned and operated by the respective financial institutions.

The model storage unit 201 stores a trained model for analyzing financial transaction information. Each of trained models is generated for a respective one of the financial institutions. The model concealing unit 202 conceals the model stored in the model storage unit 201. The model output unit 203 outputs the concealed model to the secure computing system 100 via a communication network.

Each of the financial institution systems 200 may further include a model generation unit 204 (204a, 204b), a customer information storage unit 205 (205a, 205b), and an input/output unit 206 (206a, 206b).

The customer information storage unit 205 stores financial transaction information held by each financial institution.

The model generation unit 204 generates a model based on the information stored in the customer information storage unit 205. Each model generation unit 204 generates a model for each financial institution based on financial transaction information about a customer held by each financial institution. That is, the model generation unit 204a according to the first example embodiment generates a model based on information in the customer information storage unit 205a, and the model generation unit 204b generates a model based on information in the customer information storage unit 205b.

For example, the model generation unit 204 generates a model by learning a relationship between whether or not a customer purchases a certain financial product and whether or not the customer purchases another financial product. The model generation unit 204 may generate a model based on financial transaction information including a customer attribute. For example, the model generation unit 204 generates a model by learning a relationship between a customer attribute and deposit/withdrawal information or a history of purchase of a financial product. Alternatively, the model generation unit 204 may generate a model based on financial transaction information not including a customer attribute. The model generation unit 204 stores the generated model to the model storage unit 201.

The input/output unit 206 transmits financial transaction information about a customer to be analyzed to the secure computing system 100 via the communication network. In a case where a model to be used is not generated based on the customer attribute held by each financial institution, the input/output unit 206 may not transmit the customer attribute of the customer to be analyzed. In a case where the model to be used is generated based on the customer attribute, the input/output unit 206 may or may not transmit the customer attribute of the customer to be analyzed.

The input/output unit 206 receives a result of analysis executed by the secure computing system 100. The received analysis result is displayed on an arbitrary display, for example.

The input/output unit 206 may acquire financial transaction information about the customer from the customer information storage unit 205 and transmit the financial transaction information to the secure computing system 100. The input/output unit 206 may conceal the financial transaction information and transmit the concealed financial transaction information to the secure computing system 100. The input/output unit 206 is an example of an input/output device.

### (Examples of Models)

Each of the models is trained in advance by machine learning in order to output a specific analysis result using, for example, financial transaction information about a customer in each financial institution.

Examples of such a model include a model for purchase prediction. The model for purchase prediction outputs a prediction of whether or not a financial product of a financial institution is recommended or a prediction of which financial product is recommended when a customer attribute or a status of a past transaction is input to the model.

The model for purchase prediction includes, for example, a model that receives a customer attribute or a status of a transaction in a past certain period as an input value, and outputs a possibility that a customer purchases a financial product. A result of analyzing a possibility that the customer purchases the financial product may be represented by two choices of whether the customer purchases or does not purchase it. Alternatively, the result of analyzing the possibility of the purchase or the like may be represented by a probability such as a proportion. The analysis result may be represented by three or more types of options instead of a binary value such as whether the customer purchases or does not purchase the financial product. The analysis result may be represented by a rank or a score.

The model may predict and output a customer who purchases a financial product among a plurality of customers based on input of information regarding the plurality of customers. The model may output a plurality of customers who are predicted to purchase a financial product.

The model may learn and predict attributes of a customer who purchases a financial product. The model may predict and output a customer group who purchases a financial product. The output customer group has, for example, one or more common attributes.

The model may predict and output a financial product that a customer may purchase, based on input of information about the customer. The model may output a plurality of financial products as financial products that a customer may purchase.

The models for machine learning include, but is not limited to, a decision tree model, a linear regression model, a logistic regression model, a neural network model, and the like.

### <Secure Computing System 100>

Next, the secure computing system 100 which is a basic configuration of the present embodiment will be described in detail. The secure computing system 100 is an example of a second system. The secure computing system 100 includes a secure computing unit 101 and an output unit 102.

### (Analysis Through Secure Computation)

The secure computing unit 101 performs analysis regarding a financial transaction through secure computation based on a plurality of models generated for each of the plurality of financial institutions and financial transaction information about a customer to be analyzed. The secure computation is computation performed while keeping data concealed. Specifically, the secure computation here is to perform analysis while each of the plurality of models and the financial transaction information about the customer to be analyzed are concealed.

As a method for the secure computation, special encryption corresponding to specific processing such as homomorphic encryption, a trusted execution environment in which processing is performed in a state of being isolated on hardware, multi-party computation in which computation processing (secret sharing computation) is performed in a state of being secretly shared by a plurality of servers, or the like can be used.

A specific method of secure computation of the multi-party computation includes the following examples. For example, concealed data a is secretly shared as variance values x, y, . . . , and each of x, y, . . . is transmitted to the servers. Next, in a state where the concealed data a is secretly shared, the servers perform computation while communicating with each other. Finally, variance values u, v, . . . of outputs, which are computation results of the respective servers, are collected and restoration processing is performed to obtain F(a) of the computation results. This computation result is an analysis result regarding the financial transaction of the customer. Therefore, in a case where the multi-party computation is used as the secure computation method, the secure computing unit 101 is implemented by a plurality of servers. According to the multi-party computation, management of an encryption key and an isolated environment are unnecessary, and computation processing is generally faster.

The secure computing unit 101 may perform analysis through secure computation using, for example, the models concealed by secret sharing and the financial transaction information concealed by secret sharing.

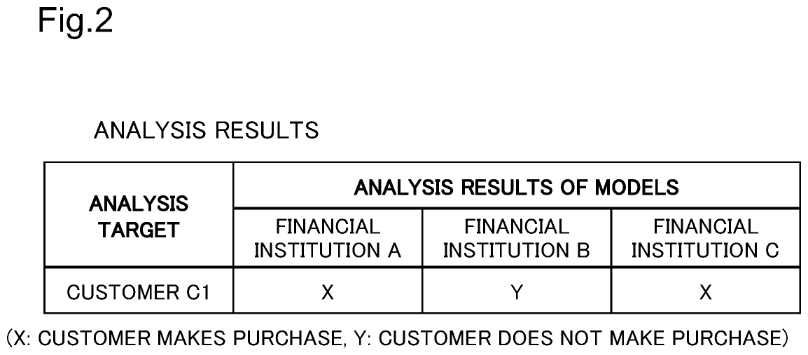

The secure computing unit 101 inputs the financial transaction information about the customer to be analyzed to each of the plurality of models generated for each of the plurality of financial institutions, and obtains a plurality of analysis results. FIG. 2 is a diagram illustrating an example of the results of the analysis by each model. In FIG. 2, for example, X indicates that the customer is analyzed to purchase a certain financial product, and Y indicates that the customer is analyzed not to purchase a financial product. An “analysis target” indicates which customer's financial transaction information is input to each model. FIG. 2 illustrates that a customer C1 is analyzed to purchase a financial product when information regarding an asset of the customer C1 is input to a model generated based on information held by a financial institution A.

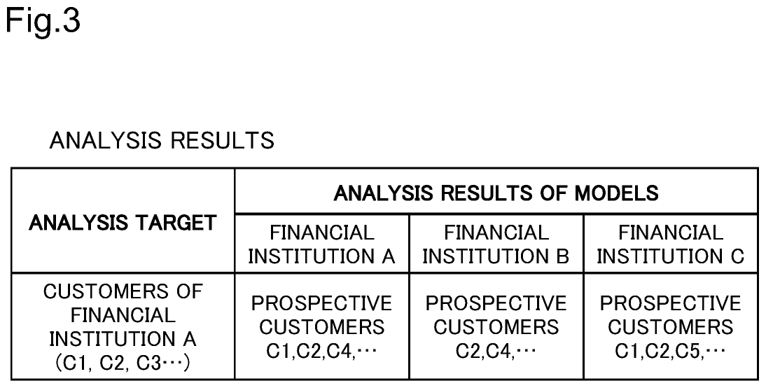

Each model may output a plurality of values including a plurality of customers or a plurality of financial products as an analysis result. FIG. 3 is a diagram illustrating another example of the results of the analysis by each model. In FIG. 3, customers C1, C2, C4, . . . are output as prospective customers who may purchase a certain financial product according to the model of the financial institution A.

When the financial institutions have different target customer groups or different trading ranges, tendencies indicated by the customer information held by the financial institutions may be different. Therefore, there is a possibility that an analysis result obtained by a learning model based on information held by one institution may be different from an analysis result obtained by a learning model based on information held by another institution.

### (Output of Analysis Results)

The secure computing unit 101 transmits the analysis results of the models to the output unit 102. The output unit 102 outputs the analysis results of the models computed by the secure computing unit 101. The output unit 102 outputs the analysis results to the input/output units 206 of the financial institution systems 200, for example.

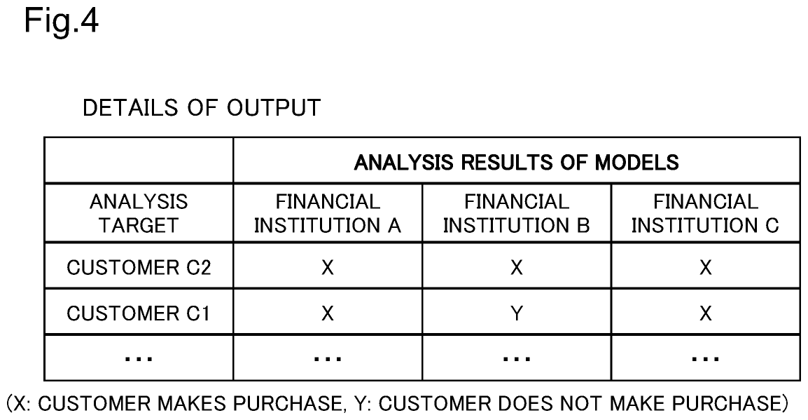

A method of outputting the analysis results is not particularly limited. The output unit 102 may output an analysis result indicating which model has performed what analysis. FIG. 4 is a diagram illustrating an example of output based on the analysis results in FIG. 3. FIG. 4 shows that according to the models of the financial institutions A and C, the customer C1 is analyzed to purchase a financial product, and according to the model of the financial institution B, the customer C1 is analyzed not to purchase a financial product.

The output unit 102 may rearrange and output the analysis results in an arbitrary order based on the number of models in which the same analysis result is computed. The same analysis result is not limited to analysis results that are completely the same, and may be analysis results that are slightly different and can be regarded as the same. For example, the same analysis result may be analysis results from which the same determination is derived. The output unit 102 outputs, for example, an aggregation result for displaying analysis results in descending order of the number of models that computed the same analysis result. In FIG. 4, for example, the analysis results are displayed in descending order of the number of models that analyzed that a prospective customer purchases a financial product.

The output unit 102 may output the number or ratio of models that computed the same analysis result together with what kind of analysis has been performed by which model.

The output unit 102 may output the analysis result of each of the models in a format in which it is not possible to specify which models the analysis results are obtained from. In a case where the output unit 102 outputs the analysis results in an unspecifiable format and does not indicate which models the analysis results are obtained from, the risk that the tendencies of the analysis of the models leak can be reduced.

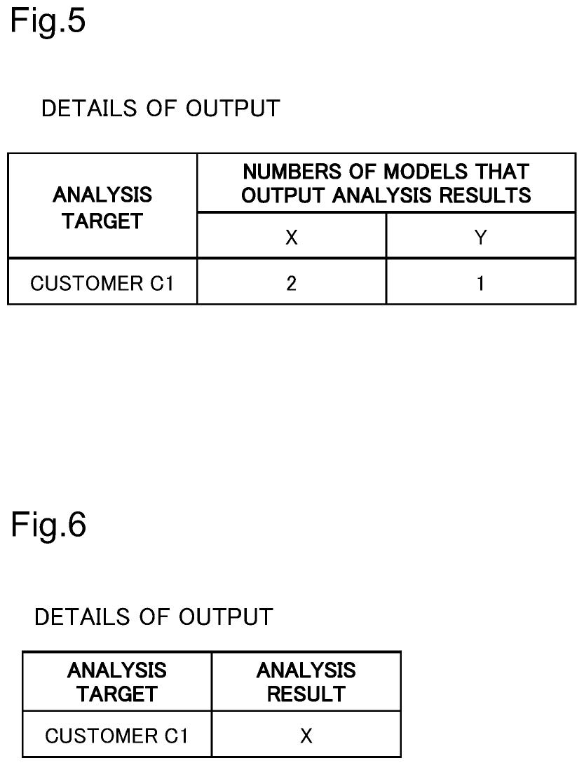

As an example of a format in which it is not possible to specify which models the analysis results are obtained from, for example, the output unit 102 may output the number of models that output respective analysis results for each analysis result. The output unit 102 may output the ratio of the models that output the respective analysis results. FIG. 5 is a diagram illustrating an example of an output based on the analysis results in FIG. 2. FIG. 5 shows that analysis results of X are obtained from two models, and an analysis result of Y is obtained from one model.

The output unit 102 outputs the number of models that output the respective analysis results or the ratio of the models, thereby indicating the tendency of the analysis results and the certainty of the analysis.

The output unit 102 may aggregate and output the respective analysis results analyzed by the plurality of models. Aggregating the analysis results includes representing the plurality of analysis results with a smaller number of analysis results or values. The output aggregated analysis results are also referred to as an aggregation result. The output unit 102 may output the aggregation result together with which models have performed what analysis, or may output the aggregation result without indicating which models the analysis results are obtained from.

As an example of the aggregation, the output unit 102 may output the analysis results based on the number of models that obtain analysis results from which the same determination is derived. For example, the output unit 102 may output the analysis results based on a majority decision by the plurality of models. Specifically, the output unit 102 may output an analysis result obtained by the largest number of models that computed the same analysis result. FIG. 6 is a diagram illustrating another example of output of an analysis result. Since the number of models that performed analysis to obtain X is the largest in the analysis results in FIG. 2, the output unit 102 may output X as the analysis result for the customer C1 as illustrated in FIG. 6.

Since the output unit 102 outputs one analysis result, a simple and easy-to-understand result for the user can be obtained. An analysis result based on a plurality of models can be indicated without indicating which model has output what analysis result.

The output unit 102 may output one aggregation result, but the number of aggregation results is not limited to one. The output unit 102 may aggregate and output analysis results for each of a plurality of groups each including two or more of the models.

For example, the output unit 102 may include, in the output, analysis results computed by models that computed the same analysis result and of which the numbers are the second and subsequent largest. The output unit 102 may output the number or ratio of the models that output the analysis results in both cases where the number of analysis results to be output is one and where the number of analysis results to be output is two or more.

As another example of the aggregation, the output unit 102 may output an average of scores of the analysis results output by the models as an analysis result. Alternatively, the output unit 102 may output a score obtained by weighting the score of the analysis result for each of the models. The weight for each of the models is determined by an arbitrary method. Since the output unit 102 outputs the scores based on the scores of the plurality of analysis results, it is possible to output the analysis results based on the analysis of each of the models without indicating a specific score of each of the models.

The output unit 102 may output a result of analysis by one model and a result obtained by aggregating analysis results by a plurality of models in a comparable manner. The analysis result of the one model may be aggregated so as to be included in the aggregation result to be compared, or may not be included at the time of the aggregation. The one model for comparison is arbitrarily determined, but may be, for example, a model acquired from a financial institution system 200 that has acquired financial transaction information about the customer to be analyzed.

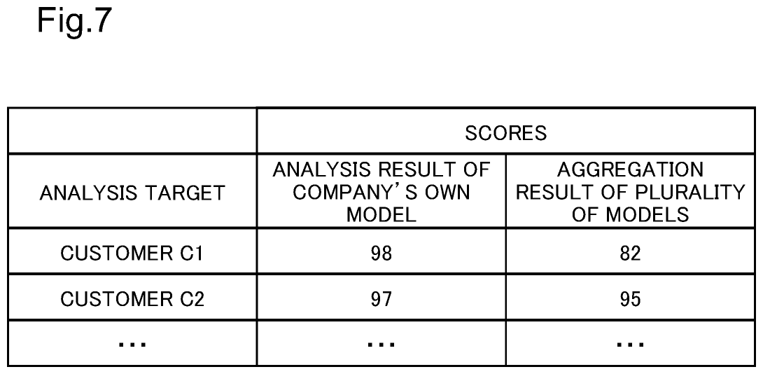

FIG. 7 is a diagram illustrating an example of comparison between the analysis results and the aggregation result output by the output unit 102. For example, a person in charge of the financial institution A operates the financial institution system 200 in such a way that the input/output unit 206 transmits information about a customer of the financial institution A. As illustrated in FIG. 7, the output unit 102 arranges, side by side, the analysis result of the model of the financial institution A and the result of aggregating the analysis results of the plurality of models, and outputs the analysis result of the model of the financial institution A and the result of aggregating the analysis results of the plurality of models. In FIG. 7, the aggregation result is, for example, an average of scores analyzed by each of the plurality of models. As a result, the person in charge can easily make a comparison as to whether the analysis result of the company's own model is different from the analysis results of the other models.

In FIG. 7, the number and order of the output analysis results are determined by an arbitrary method. The number and order may be determined, for example, based on similarity between the analysis result of the one model and the aggregation result of the plurality of other models. The output unit 102 outputs, for example, an analysis result in which the analysis result and the aggregation result match. Alternatively, the output unit 102 outputs the analysis results in the order in which the analysis results are similar to the aggregation result.

### (Example of Operation)

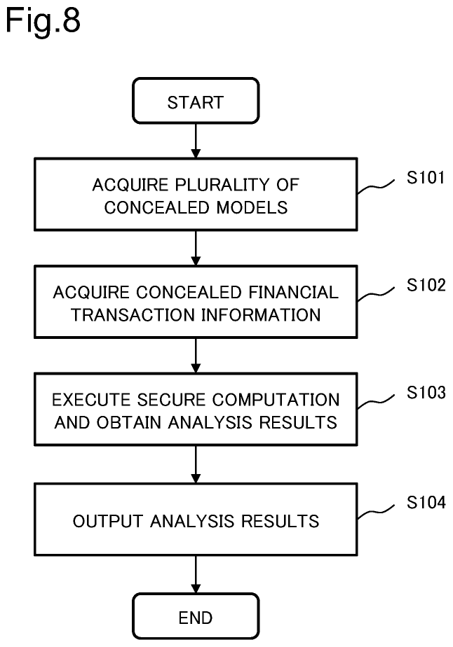

The operation of the secure computing system 100 configured as described above will be described. FIG. 8 is a flowchart illustrating an example of the operation of the secure computing system 100.

The secure computing unit 101 acquires a concealed model from each of the plurality of financial institution systems 200 (step S101). For example, the secure computing unit 101 acquires the models from the model output units 203a and 203b. The secure computing unit 101 may acquire the models from the financial institution systems 200 each time analysis is performed. Alternatively, the secure computing unit 101 may acquire the concealed models received in advance from the financial institution systems 200 from a storage unit (not illustrated).

The secure computing unit 101 acquires concealed financial transaction information about a customer from the financial institution systems 200 (step S102). For example, the secure computing unit 101 acquires financial transaction information about the customer to be analyzed from the input/output unit 206a of the financial institution system 200a. In this case, the secure computing unit 101 may acquire financial transaction information about a plurality of customers.

The secure computing unit 101 executes secure computation and obtains results of analysis by each of the plurality of models (step S103). Specifically, the secure computing unit 101 inputs the concealed financial transaction information about the customer to each of the concealed models, and obtains the plurality of analysis results. In analysis based on the information acquired from the financial institution system 200a, the secure computing unit 101 may omit analysis by the model acquired from the model output unit 203a of the financial institution system 200a. This is because the analysis by the model may be omitted or may be performed in the financial institution system 200a. The secure computing system 100 may acquire the result of the analysis by the model from the financial institution system 200a.

The output unit 102 acquires the plurality of analysis results from the secure computing unit 101 and outputs the analysis results (step S104). Specifically, for example, the aggregation result is output to the input/output unit 206a of the financial institution system 200a that transmitted the financial transaction information about the customer to be analyzed.

According to the embodiment, the secure computing unit 101 performs analysis through secure computation by using each of the models based on the plurality of models and the financial transaction information about the customer. The output unit 102 outputs the analysis results of the models computed by the secure computing unit 101. Therefore, it is possible to use the analysis result of each of the models without leaking the model of each financial institution.

### Second Example Embodiment

Next, an information processing system 11 according to a second example embodiment will be described. Similarly to the first example embodiment, the information processing system 11 according to the second embodiment is a system that performs analysis regarding a financial transaction based on financial transaction information using a model held by each of financial institutions. Hereinafter, description of contents overlapping with the above description will be omitted to the extent that the description of the present example embodiment is not unclear.

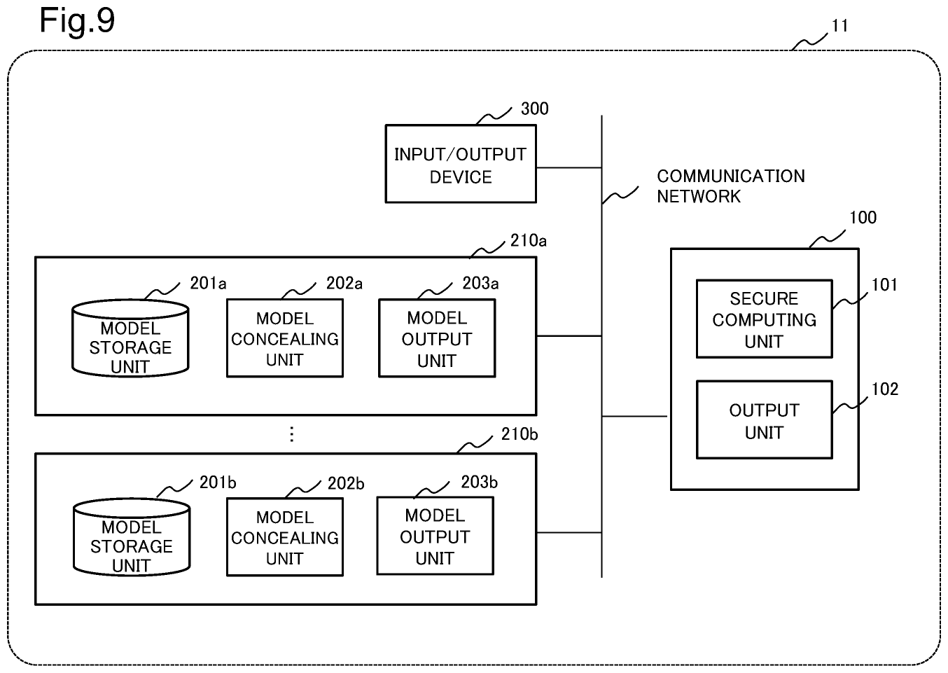

FIG. 9 is a block diagram illustrating a configuration of the information processing system 11 according to the second example embodiment. The information processing system 11 includes a secure computing system 100, a plurality of financial institution systems 210 (210a, 210b), and an input/output device 300. In FIG. 9, the number of financial institution systems 210 is two, but is not limited thereto. The plurality of financial institution systems 200 may be provided as many as the number of financial institutions participating in the analysis by the information processing system. The number of input/output devices 300 is not limited to one, and a plurality of input/output devices 300 may be included.

The configuration of the secure computing system 100 is basically similar to that of the secure computing system 100 according to the first example embodiment. The secure computing system 100 is an example of the second system.

Each of the financial institution systems 210 includes a model storage unit 201, a model concealing unit 202, and a model output unit 203, similarly to the financial institution systems 200 according to the first example embodiment. Each of the financial institution systems 210 is an example of the first system.

The model storage unit 201 may store in advance trained models for analyzing financial transaction information. Each of the trained models is a model generated for each of the financial institutions. Since financial transaction information about a customer held by each of the plurality of financial institutions is different, the models generated for the financial institutions are different. The model storage units 201a and 201b store the different models.

The model output unit 203 transmits the model concealed by the model concealing unit 202 to the secure computing system 100. The model concealing unit 202 may be included in the model output unit 203.

In the second example embodiment, a case where each of the financial institution systems 210 does not include the model generation unit 204, the customer information storage unit 205, and the input/output unit 206 of the financial institution system 200 according to the first example embodiment will be described. However, each of the financial institution systems 210 may include any of the model generation unit 204, the customer information storage unit 205, and the input/output unit 206.

The input/output device 300 is used to input information about a customer to be analyzed to the secure computing system 100. The input/output device 300 may be implemented by an arbitrary terminal including a personal computer, a tablet terminal, or a smartphone.

First, the input/output device 300 acquires financial transaction information about the customer to be analyzed. Specifically, the financial transaction information is input to the input/output device 300 by, for example, a person in charge of a financial institution or the customer. Alternatively, the financial transaction information is acquired from another storage unit (not illustrated) via the input/output device 300.

The input/output device 300 can be used instead of the input/output unit 206 according to the first example embodiment. That is, the information about the custom to be analyzed may not be stored in the customer information storage unit 205. In the first example embodiment, the input/output device 300 may be further provided in addition to the input/output unit 206.

The input/output device 300 conceals the acquired financial transaction information and transmits the concealed financial transaction information to the secure computing system 100. The input/output device 300 may transmit the information to a concealing unit (not illustrated) and instruct the concealing unit to conceal the information and transmit the concealed information to the secure computing system 100.

In the second example embodiment, similarly to the first example embodiment, the secure computing system 100 acquires the concealed models from the financial institution systems 210. The secure computing system 100 acquires the information about the customer to be analyzed from the input/output device 300.

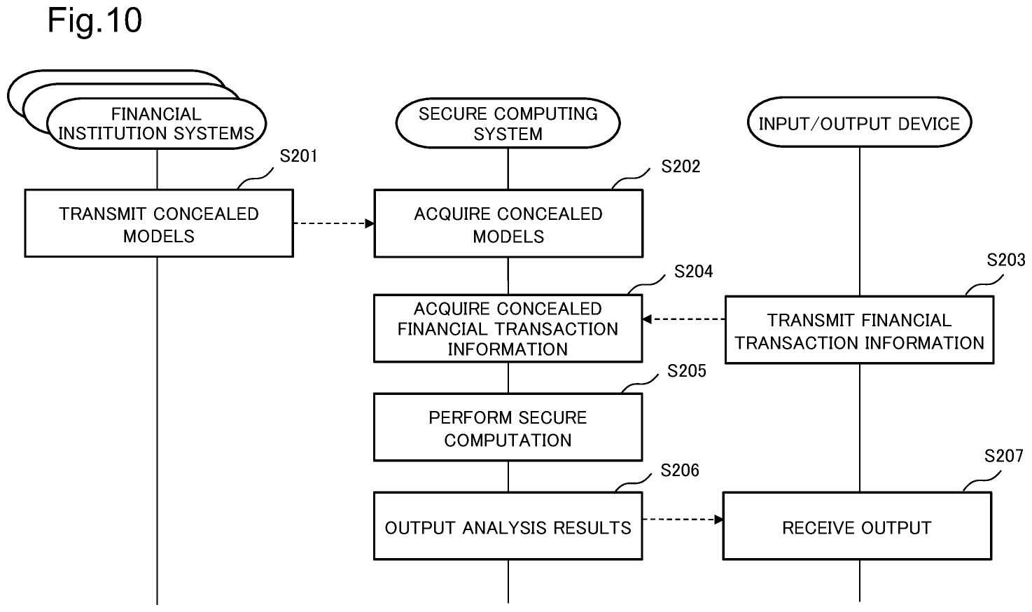

The operation of the information processing system 11 configured as described above will be described with reference to the flowchart of FIG. 10.

First, the model concealing units 202 of the financial institution systems 210 conceal the models stored in the model storage units 201. The model output units 203 transmit the concealed models to the secure computing system 100 (step S201).

The secure computing unit 101 of the secure computing system 100 acquires the concealed models (step S202).

Next, the input/output device 300 transmits the financial transaction information to the secure computing system 100 (step S203). The secure computing system 100 acquires the concealed financial transaction information from the input/output device 300 (step S204).

The secure computing unit 101 of the secure computing system 100 performs analysis through secure computation using each of the models obtained by inputting the financial transaction information to the acquired models (step S205).

The output unit 102 of the secure computing system 100 outputs the analysis results of the models (step S206) and transmits the analysis results to the input/output device 300. The input/output device 300 receives the analysis results from the secure computing system 100 (step S207).

According to the example embodiment, the model storage units 201 of the financial institution systems 200 store the models that were generated based on financial transaction information held by each of the financial institutions and perform analysis regarding a financial transaction of a customer. The model output units 203 of the financial institution systems 200 transmit the models to the secure computing system 100 in a concealed form. The input/output device 300 transmits the financial transaction information to the secure computing system 100 in a concealed form. The secure computing unit 101 of the secure computing system 100 performs analysis through secure computation using each of the models based on the plurality of concealed models and the financial transaction information. The output unit 102 of the secure computing system 100 outputs the analysis results of the models computed by the secure computing unit 101. Therefore, it is possible to use the analysis result of each of the models without leaking the model of each financial institution.

### Modifications

### <Other Examples of Models>

Examples of the models according to the first and second example embodiments further include models used for loan examination, cancellation prediction, and the like. The model for loan examination receives financial transaction information such as a customer attribute and a repayment status as an input value, and outputs an amount to be loaned. The model for cancellation prediction receives a transaction status of each financial institution in a past certain period as an input value, and outputs a result obtained by scoring a possibility of early repayment of a loan and a possibility of time deposit cancellation/account cancellation for each customer of the financial institutions.

Here, details of each model used in a financial analysis tool for corporate customers will be described. Each financial institution holds a model for M & A support based on successful examples of financial transactions for which the financial institutions have advised corporate customers in the past. The model for M & A support includes a model to be used by an acquirer and a model to be used by a seller (party to be acquired). The acquirer-side model is, for example, a model obtained by learning financial transaction information such as an industry type, sales, or a region as teacher data based on the past successful examples. This model outputs whether acquisition is possible and an acquisition amount when a name of a company desired to be acquired is input to the model. The seller-side model is, for example, a model obtained by learning financial transaction information such as an industry type, sales, or a region as teacher data based on the past successful examples. When a company name or the like of a desired acquisition target company is input to this model, the model outputs a possibility of whether the company desires acquisition or a desired expected acquisition amount. According to these models, the accuracy of matching between a buyer and a seller can be achieved, and loan opportunities can be increased.

The models may output credit information (credit line) of a customer based on an input of financial transaction information about the customer. The models are used for supporting a loan examination for setting a credit line for a customer. The model for loan examination receives, for example, a repayment status of an existing customer as an input value and outputs a loan amount (increase amount, refinancing, extension of period).

The information processing systems 10 and 11 can also use a model for human resources (evaluation/appropriateness/transfer) of the financial institutions. The model for human resources predicts a separation probability, a promotion probability, necessity of transfer, a transfer destination, and the like of an employee from human resources information about the employee in a certain past period.

### <Combination of Financial Institutions>

In the first and second example embodiments, the plurality of financial institutions are not limited to financial institutions of the same business type, and may include a bank and a financial institution other than a bank, such as a bank, a securities company, or an insurance company. Even when the plurality of financial institutions are constituted by banks, the financial institutions may be constituted by banks having different scales such as a city bank and a regional bank.

### Hardware Configuration

In each of the above-described example embodiments, each component of each of the devices including the secure computing system 100 and the financial institution systems 200 and 210 represents a block of a functional unit. Some or all of the components of each of the devices may be implemented by an arbitrary combination of the computer 500 and the program.

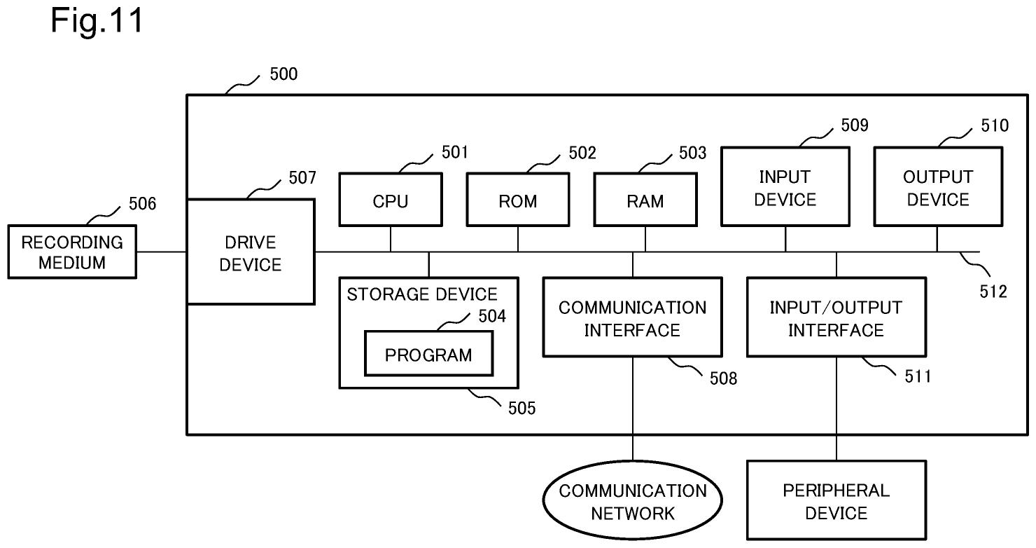

FIG. 11 is a block diagram illustrating an example of a hardware configuration of the computer 500. Referring to FIG. 11, the computer 500 includes, for example, a central processing unit (CPU) 501, a read only memory (ROM) 502, a random access memory (RAM) 503, a program 504, a storage device 505, a drive device 507, a communication interface 508, an input device 509, an input/output interface 511, and a bus 512.

The program 504 includes an instruction for implementing each function of each of the devices. The program 504 is stored in advance in the ROM 502, the RAM 503, and the storage device 505. The CPU 501 implements each function of each of the devices by executing an instruction included in the program 504. For example, the CPU 501 of the secure computing system 100 executes an instruction included in the program 504 to implement the functions of the secure computing system 100. The RAM 503 may store data to be processed in each function of each device.

The drive device 507 reads and writes data from and to a recording medium 506. The communication interface 508 provides an interface with a communication network. The input device 509 is, for example, a mouse, a keyboard, a built-in key button, a touch panel, or the like, and receives an input of information from a person in charge of a financial institution, a customer, or the like. The output device 510 is, for example, a display, and outputs (displays) information to a person in charge of a financial institution, a customer, or the like. The input/output interface 511 provides an interface with a peripheral device. The bus 512 connects the components of the hardware. The program 504 may be supplied to the CPU 501 via the communication network, or may be stored in the recording medium 506 in advance, read by the drive device 507, and supplied to the CPU 501.

The hardware configuration illustrated in FIG. 11 is an example, and other components may be added or some of the components may not be included.

There are various modifications of a method of implementing each of the devices. For example, each of the devices may be implemented by an arbitrary combination of a computer and a program different for each component. A plurality of components included in each of the devices may be implemented by an arbitrary combination of one computer and a program.

Some or all of the components of each of the devices may be implemented by general-purpose or dedicated circuitry including a processor or the like, or a combination thereof. These circuits may be configured by a single chip or may be configured by a plurality of chips connected via a bus. Some or all of components of each device may be implemented by an arbitrary combination of the above-described circuits and a program.

In a case where some or all of components of each of the devices is implemented by a plurality of computers, circuits, or the like, the plurality of computers, circuits, or the like may be arranged in a centralized manner or in a distributed manner.

Although the present disclosure has been described above with reference to the example embodiments, the present disclosure is not limited to the above example embodiments. Various modifications that can be understood by those skilled in the art can be made to the configuration and details of the present disclosure within the scope of the present disclosure. In addition, the configurations in the respective example embodiments can be combined with each other without departing from the scope of the present disclosure.

For example, although the plurality of operations are described in order in the form of the flowcharts, the order of description does not limit the order of executing the plurality of operations. Therefore, when each example embodiment is implemented, the order of the plurality of operations can be changed within a range that does not affect the content.

Some or all of the above example embodiments can be described as the following supplementary notes, but are not limited to the following.

### Supplementary Note 1

A secure computing system includes
a secure computing means that performs, based on a plurality of models and financial transaction information about a customer to be analyzed, analysis regarding a financial transaction of the customer to be analyzed, through secure computation using each of the models, the plurality of models having been generated for a plurality of financial institutions based on financial transaction information about customers held by each of the financial institutions, and
an output means that outputs results of the analysis performed by the secure computing means using the plurality of models.

### Supplementary Note 2

In the secure computing system as recited in Supplementary Note 1, in which
the output means outputs the analysis results of the models in a format in which it is not possible to specify which models the analysis results are obtained from.

### Supplementary Note 3

In the secure computing system as recited in Supplementary Note 1 or 2, in which
the output means aggregates and outputs the analysis results analyzed by the plurality of models.

### Supplementary Note 4

In the secure computing system as recited in Supplementary Note 3, in which
the output means aggregates the analysis results based on the number of models that obtain analysis results from which the same determination is derived, and outputs the analysis results.

### Supplementary Note 5

In the secure computing system as recited in Supplementary Note 4, in which
the output means outputs the analysis results based on a majority decision by the plurality of models.

### Supplementary Note 6

In the secure computing system as recited in any one of Supplementary Notes 1 to 5, in which
the output means further outputs the number or ratio of the models that analyze the analysis results to be output.

### Supplementary Note 7

In the secure computing system as recited in any one of Supplementary Notes 1 to 6, in which
the secure computing means performs secure computation by analyzing the models concealed by secret sharing and the financial transaction information concealed by secret sharing.

### Supplementary Note 8

In the secure computing system as recited in any one of Supplementary Notes 1 to 7, in which
each of the models is a model that analyzes a possibility that the customer purchases a financial product.

### Supplementary Note 9

In the secure computing system as recited in any one of Supplementary Notes 1 to 7, in which
each of the models is a model that predicts a financial product that the customer is likely to purchase.

### Supplementary Note 10

In the secure computing system as recited in any one of Supplementary Notes 1 to 7, in which
each of the models is a model that predicts a customer predicted to purchase a financial product.

### Supplementary Note 11

In the secure computing system as recited in any one of Supplementary Notes 1 to 7, in which
each of the models is a model that analyzes whether a desired partner for M & A can be acquired, or analyzes a desired expected acquisition amount.

### Supplementary Note 12

In the secure computing system as recited in any one of Supplementary Notes 1 to 7, in which
each of the models is a model that outputs credit information of the customer.

### Supplementary Note 13

A method includes
performing, based on a plurality of models and financial transaction information about a customer to be analyzed, analysis regarding a financial transaction of the customer to be analyzed, through secure computation using each of the models, the plurality of models having been generated for a plurality of financial institutions based on financial transaction information about customers held by each of the financial institutions, and
outputting analyzed analysis results of the models.

### Supplementary Note 14

A recording medium non-temporarily storing a program for causing a computer to execute
performing, based on a plurality of models and financial transaction information about a customer to be analyzed, analysis regarding a financial transaction of the customer to be analyzed, through secure computation using each of the models, the plurality of models having been generated for a plurality of financial institutions based on financial transaction information about customers held by each of the financial institutions, and
outputting computed analysis results of the models.

### Supplementary Note 15

An information processing system including a plurality of first systems, an input/output device, and a second system, in which
each of the plurality of first systems includes
a model storage unit that stores a model that was generated based on financial transaction information about customers held by each financial institution and performs analysis regarding a financial transaction of a customer, and
a model output means that transmits the model to the second system in a concealed form,
the input/output device transmits financial transaction information about the customer to be analyzed to the second system in a concealed form, and
the second system includes
a secure computing means that performs, based on the plurality of models acquired from the plurality of first systems and the financial transaction information about the customer to be analyzed, analysis regarding a financial transaction of the customer to be analyzed, through secure computation using each of the models, the financial transaction information being acquired from the input/output device, and
an output means that outputs analysis results of the models analyzed by the secure computing means to the input/output device.

### REFERENCE SIGNS LIST

100 secure computing system
101 secure computing unit
102 output unit
200, 210 financial institution system
201 model storage unit
202 model concealing unit
203 model output unit
204 model generation unit
205 customer information storage unit
206 input/output unit
300 input/output device
500 computer

What is claimed is:

1. A secure computing system comprising:
at least one memory configured to store instructions; and
at least one processor configured to execute the instructions to:
perform, based on a plurality of models and financial transaction information about a customer to be analyzed, analysis regarding a financial transaction of the customer to be analyzed, through secure computation using each of the models, the plurality of models having been generated for a plurality of financial institutions based on financial transaction information about customers held by each of the financial institutions; and
output results of the analysis performed by the secure computing means using the plurality of models.

2. The secure computing system according to claim 1, wherein the at least one processor is further configured to execute the instructions to:
output the analysis results of the models in a format in which it is not possible to specify which models the analysis results are obtained from.

3. The secure computing system according to claim 1, wherein the at least one processor is further configured to execute the instructions to:
aggregate and output the analysis results analyzed by the plurality of models.

4. The secure computing system according to claim 3, wherein the at least one processor is further configured to execute the instructions to:
aggregate the analysis results based on the number of models that obtain analysis results from which the same determination is derived, and output the analysis results aggregated.

5. The secure computing system according to claim 4, wherein the at least one processor is further configured to execute the instructions to:
output the analysis results based on a majority decision by the plurality of models.

6. The secure computing system according to claim 1, wherein the at least one processor is further configured to execute the instructions to:
output the number or ratio of the models that analyze the analysis results to be output.

7. The secure computing system according to claim 1, wherein the at least one processor is further configured to execute the instructions to:
perform secure computation by analyzing the models concealed by secret sharing and the financial transaction information concealed by secret sharing.

8. The secure computing system according to claim 1, wherein
each of the models is a model that analyzes a possibility that the customer purchases a financial product.

9. The secure computing system according to claim 1, wherein
each of the models is a model that predicts a financial product that the customer is likely to purchase.

10. The secure computing system according to claim 1, wherein
each of the models is a model that predicts a customer predicted to purchase a financial product.

11. The secure computing system according to claim 1, wherein
each of the models is a model that analyzes whether a desired partner for M & A can be acquired, or analyzes a desired expected acquisition amount.

12. The secure computing system according to claim 1, wherein
each of the models is a model that outputs credit information of the customer.

13. A method comprising
performing, based on a plurality of models and financial transaction information about a customer to be analyzed, analysis regarding a financial transaction of the customer to be analyzed, through secure computation using each of the models, the plurality of models having been generated for a plurality of financial institutions based on financial transaction information about customers held by each of the financial institutions, and
outputting analyzed analysis results of the models.

14. A recording medium non-temporarily storing a program for causing a computer to execute:
performing, based on a plurality of models and financial transaction information about a customer to be analyzed, analysis regarding a financial transaction of the customer to be analyzed, through secure computation using each of the models, the plurality of models having been generated for a plurality of financial institutions based on financial transaction information about customers held by each of the financial institutions; and
outputting computed analysis results of the models.

15. An information processing system comprising a plurality of first systems, an input/output device, and a second system, wherein
each of the plurality of first systems includes
at least one memory configured to store instructions and a model that was generated based on financial transaction information about customers held by each financial institution and performs analysis regarding a financial transaction of a customer, and
at least one processor configured to execute the instructions to transmit the model to the second system in a concealed form,
the input/output device transmits financial transaction information about the customer to be analyzed to the second system in a concealed form, and the second system includes at least one processor configured to execute the instructions to:
perform, based on the plurality of models acquired from the plurality of first systems and the financial transaction information about the customer to be analyzed, analysis regarding a financial transaction of the customer to be analyzed, through secure computation using each of the models, the financial transaction information being acquired from the input/output device, and
output analysis results of the models analyzed by the secure computing means to the input/output device.
